(19) United States
(12) Patent Application Publication
(10) Pub. No.: US 2025/0102737 A1
(43) Pub. Date: Mar. 27, 2025

(54) CONNECTOR FOR OPTICAL WAVEGUIDE ARRAYS

(71) Applicant: Mellanox Technologies, Ltd., Yokneam (IL)

(72) Inventors: Hassid C. Gurgov, Binyamina (IL); Barak FREEDMAN, Binyamina (IL); Amit OREN, Ramat Hasharon (IL)

(21) Appl. No.: 18/371,485

(22) Filed: Sep. 22, 2023

(51) Int. Cl. G02B 6/30

(52) U.S. Cl. CPC G02B 6/30

(57) ABSTRACT

Connectors for optical waveguide arrays (WGAs) are described herein. Some embodiments include an optical array connector that includes one component configured to mechanically connect to one WGA and another component configured to mechanically connect to another WGA. The components may be configured to removably connect to each other, mechanically connect the WGAs to each other, and optically align each waveguide of one WGA to a corresponding waveguide of the other WGA. In some embodiments, one component may be configured to expand and collimate light beams from one WGA, and the other component may be configured to focus each collimated light beam onto proximal apertures of the other WGA. Additionally, or alternatively, the components may be configured to direct the light beams via total internal reflection. In some embodiments, one or more of the components may include a microlens array and/or another WGA.

### FIELD OF THE INVENTION

The present invention relates to connectors for optical waveguide arrays.

### BACKGROUND

An optical network and/or a photonic device may include a plurality of optical waveguide arrays (WGAs). The WGAs may be connected to each other via one or more optical connectors that mechanically connect and optically align the WGAs.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. This summary presents some concepts of one or more embodiments of the present invention in a simplified form as a prelude to the more detailed description that is presented later.

In one aspect, the present invention is directed to an optical array connector that includes a first component configured to mechanically connect to a first array of first waveguides, where the first component includes a first array of first curved surfaces, each first curved surface corresponding to a respective first waveguide. The optical array connector may include a second component configured to mechanically connect to a second array of second waveguides, where the second component includes a second array of second curved surfaces, each second curved surface corresponding to a respective second waveguide. The first component and the second component may be configured to removably connect to each other, mechanically connect the first array to the second array, and/or optically align each first waveguide with a corresponding second waveguide. The first component may be configured to expand and collimate each light beam from the first array of first waveguides using a corresponding first curved surface and direct each collimated light beam to the second component. The second component may be configured to focus each collimated light beam onto a respective aperture of a corresponding second waveguide of the second array of second waveguides using a corresponding second curved surface.

In some embodiments, the first array of first waveguides may include an array of optical fibers fixed to a substrate, an array of waveguides fabricated on a substrate and/or a photonic integrated circuit that are edge-coupled, an array of waveguides fabricated on a substrate and/or a photonic integrated circuit with surface-emitting grating couplers, and/or an array of waveguides including grating couplers having optical components configured to collimate grating coupled light.

In some embodiments, the second array of second waveguides may include an array of optical fibers fixed to a substrate, an array of waveguides fabricated on a substrate and/or a photonic integrated circuit that are edge-coupled, an array of waveguides fabricated on a substrate and/or a photonic integrated circuit with surface-emitting grating couplers, and/or an array of waveguides including grating couplers having optical components configured to collimate grating coupled light.

In some embodiments, the first component may be configured to direct each collimated light beam to the second component via total internal reflection. Additionally, or alternatively, the first array of first curved surfaces may include a plurality of first lenses on a first internal surface of the first component, where each first lens is configured to collimate a respective light beam within the first component. In some embodiments, the second array of second curved surfaces may include a plurality of second lenses on a second internal surface of the second component, where each second lens is configured to focus a respective collimated light beam within the second component.

Additionally, or alternatively, the first component may be configured to reflect each light beam from the first array of first waveguides and direct each collimated light beam to the second component using the first internal surface. In some embodiments, each of the first component and the second component may include a corresponding external flat surface configured to allow each collimated light beam to pass therethrough. Additionally, or alternatively, the second component may be configured to direct each focused light beam into a respective aperture of a corresponding second waveguide using the second internal surface.

In some embodiments, the first component may include a third internal surface, and the first component may be configured to (i) direct each light beam from the first array of first waveguides to the first internal surface using the third internal surface and (ii) direct each collimated light beam to the second component using the first internal surface. Additionally, or alternatively, each of the first component and the second component may include a complementarily shaped external surface configured to allow each collimated light beam to pass therethrough. In some embodiments, the second component may include a fourth internal surface, and the second component may be configured to (i) direct each focused light beam to the fourth internal surface using the second internal surface and (ii) direct each focused light beam into a respective aperture of a corresponding second waveguide using the fourth internal surface.

In another aspect, the present invention is directed to an optical array connector that includes a first component configured to mechanically connect to a first array of first waveguides and a second component configured to mechanically connect to a second array of second waveguides. The second component may include a housing and a microlens array positioned within the housing. The first component and the second component may be configured to removably connect to each other, mechanically connect the first array to the second array, and/or optically align each first waveguide with a respective second waveguide.

In some embodiments, the housing may define a first side and a second side opposite the first side, and each microlens of the microlens array may have a first focal point a first distance from the first side of the microlens array and a second focal point a second distance from the second side of the microlens array. Additionally, or alternatively, the housing may be configured to, when the first component and the second component are connected to each other, (i) position proximal apertures of the first waveguides the first distance from the first side of the microlens array and (ii) position proximal apertures of the second waveguides the second distance from the second side of the microlens array.

In some embodiments, the second array of second waveguides may be a portion of a photonic integrated circuit, and the second component may be fixedly attached to the photonic integrated circuit.

In some embodiments, the first component may be a photonic integrated circuit, and the second component may be a fiber array unit. Additionally, or alternatively, the housing may define a first side and a second side opposite the second side, and each microlens of the microlens array may have a first focal point a first distance from the first side of the microlens array and a second focal point a second distance from the second side of the microlens array. In some embodiments, the housing may be configured to, when the fiber array unit and the photonic integrated circuit are connected to each other, (i) position proximal apertures of the first waveguides the first distance from the first side of the microlens array and (ii) position proximal apertures of the second waveguides the second distance from the second side of the microlens array.

In some embodiments, the microlens array may include a first surface positioned adjacent proximal apertures of the second waveguides and a second surface having a plurality of microlenses formed thereon, where each microlens of the plurality of microlenses has a first focal point a first distance from the second surface. Additionally, or alternatively, the housing may be configured to, when the fiber array unit and the photonic integrated circuit are connected to each other, position proximal apertures of the first waveguides the first distance from the second surface of the microlens array.

In another aspect, the present invention is directed to an optical array connector that includes a substrate including a first side configured to mechanically connect to a first array of first waveguides and a second side configured to mechanically connect to a second array of second waveguides. The optical array connector may include a third array of third waveguides disposed on the substrate and configured to collimate and couple each light beam from the first array of first waveguides to a corresponding second waveguide.

In some embodiments, each third waveguide may expand a corresponding light beam from a corresponding first waveguide.

In some embodiments, the third array of third waveguides may be fabricated on the substrate via lithography.

In some embodiments, the substrate may include a planar lightwave circuit.

In some embodiments, the optical array connector may include an array of optical components, where each optical component is configured to focus a respective collimated light beam onto a corresponding proximal aperture of the corresponding second waveguide.

In some embodiments, the second side of the substrate may be angle-polished and configured to direct light from the third array of third waveguides to the second waveguide. Additionally, or alternatively, the second side may be configured to direct the light at an angle with respect to the substrate.

The features, functions, and advantages that have been discussed may be achieved independently in various embodiments of the present invention or may be combined with yet other embodiments, further details of which may be seen with reference to the following description and drawings.

### BRIEF DESCRIPTION OF THE DRAWINGS

Having thus described embodiments of the invention in general terms, reference will now be made the accompanying drawings, wherein:

FIG. 1A is a perspective view of an array of waveguides (i.e., a WGA), in accordance with an embodiment of the invention;

FIGS. 1B-1D are schematic cross-sectional views of other arrays of waveguides (i.e., WGAs), in accordance with embodiments of the invention;

FIG. 2 is a perspective view of two waveguide arrays (WGAs) and an optical array connector, in accordance with an embodiment of the invention;

FIGS. 3A-3C are schematic top views of optical fibers coupled to single waveguide photonic integrated circuits (PICs) by optical array connectors using an expanded-beam technique;

FIG. 4A is cross-sectional view of two WGAs connected by an optical array connector, in accordance with an embodiment of the invention;

FIGS. 4B and 4C are perspective views of components of the optical array connector of FIG. 4A;

FIG. 5A is an elevation view of two WGAs connected by an optical array connector, in accordance with an embodiment of the invention;

FIGS. 5B and 5C are perspective views of components of the optical array connector of FIG. 5A;

FIG. 6A is a schematic elevation view of two WGAs and an optical array connector before connection, in accordance with an embodiment of the invention;

FIG. 6B is a schematic elevation view of the two WGAs and the optical array connector of FIG. 6A after connection;

FIG. 6C is a schematic overhead view of the two WGAs and the optical array connector of FIG. 6A after connection;

FIG. 7A is a schematic elevation view of two WGAs and an optical array connector before connection, in accordance with an embodiment of the invention;

FIG. 7B is a schematic elevation view of the two WGAs and the optical array connector of FIG. 7A after connection;

FIG. 7C is a schematic overhead view of the two WGAs and the optical array connector of FIG. 7A after connection;

FIG. 8A is a schematic elevation view of two WGAs and an optical array connector before connection, in accordance with an embodiment of the invention;

FIG. 8B is a schematic elevation view of the two WGAs and the optical array connector of FIG. 8A after connection;

FIG. 8C is a schematic overhead view of the two WGAs and the optical array connector of FIG. 8A after connection;

FIG. 9A is a schematic overhead view of two WGAs and an optical array connector, in accordance with an embodiment of the invention; and

FIG. 9B is a schematic elevation view of two WGAs and an optical array connector, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Furthermore, when it is said herein that something is “based on” something else, it may be based on one or more other things as well. In other words, unless expressly indicated otherwise, as used herein “based on” means “based at least in part on” or “based at least partially on.” Also, as used herein, the term “or” is intended to be inclusive when used in a series and may be used interchangeably with “and/or,” unless explicitly stated otherwise (e.g., if used in combination with “either” or “only one of”). Like numbers refer to like elements throughout. No element, act, or instruction used herein should be construed as critical or essential unless explicitly described as such.

As noted above, an optical network and/or an optical device may include a plurality of optical waveguide arrays (WGAs). The WGAs may be connected to each other via one or more optical connectors that mechanically connect and optically align the WGAs. The WGAs may guide information-carrying light waveforms to physically route a signal from one location to another.

Photonic Integrated Circuits (PICs) implemented in semiconductor chips have been developed to process and manipulate optical signals carried by WGAs. PICs are substantially planar structures of waveguides and photonic microdevices that require robust and low-loss interfacing with other WGAs carrying input and output optical signals. The waveguides of PICs are arranged into arrays at the inputs and/or outputs of the PICs.

When light exits a waveguide, it is no longer confined and expands in a cone-like shape (i.e., it diffracts). Thus, when building optical networks including WGAs, the optical connectors between the WGAs must securely mechanically connect and precisely optically align each pair of WGAs to ensure high-efficiency transmission of light from one WGA to the other WGA. In this regard, light may only be transmitted from a first WGA to a second WGA if light emitted by the first WGA matches the optical mode(s) supported by the second WGA when the light arrives at the second WGA.

The waveguides of a WGA typically have very small cross-sections (e.g., 1-10 microns), which results in a very small mode field diameter (MFD) for receiving and supporting light from another waveguide. Accordingly, mechanically aligning one waveguide with another waveguide is difficult. Furthermore, mechanically aligning waveguides in a re-pluggable or replaceable manner is even more difficult because detaching and re-attaching the waveguides introduces mechanical inconsistencies and departures from nominal position and angle. Such inconsistencies and departures result in misalignment of the waveguides, optical mode mismatches, and optical transmission losses.

Some embodiments of the present invention are directed to optical array connectors that include optical architectures and/or components configured around two WGAs to provide high-efficiency transmission for the waveguides of the WGAs. The optical array connectors may be tolerant to mechanical limitations of alignment precisions provided by typical adhesives and/or other mechanical constructions used to secure WGAs to each other.

In some embodiments, the optical array connectors may use an expanded-beam technique to optically align WGAs and increase resilience to misalignment. Such connectors may include a first component to expand and collimate light beams from one WGA before directing them to a second component of the connector. The second component may then focus the collimated light beams into the waveguides of the other WGA. The components may include optically transparent material and use refraction and/or internal reflection to expand, focus, and/or redirect the light.

In some embodiments, the connectors may include a first component to mechanically connect to one WGA and a second component to mechanically connect to another WGA. One of the components may include a housing and a refractive or reflective microlens array (MLA) that collects light from one WGA and refocuses it into the other WGA. The housing may support the MLA and position the MLA such that, when the components are mechanically connected, the focal point on one side of the MLA coincides with the waveguides of one WGA and the other focal point on the other side of the MLA coincides with the waveguides of the other WGA. In some embodiments, the MLA may be fixedly connected to a PIC. Alternatively, the MLA may be fixedly connected to a fiber array unit (FAU) or MT-type connector. The MLA may be configured with an airgap between the MLA and both WGAs or with a flat back side without an airgap between the MLA and one of the WGAs.

In some embodiments, the connectors may include a substrate (e.g., a silica glass substrate) including a first side to optically connect to a first WGA and a second side to optically connect to a second WGA, which may have collimating optics attached. The substrate may also include a third WGA fabricated on the substrate and configured to couple each light beam from the first WGA to a corresponding waveguide of the second WGA. The third WGA may expand and/or collimate light from the first WGA and increase resilience to misalignment. The third WGA may be fabricated on the substrate via lithography or may include a planar lightwave circuit (PLC) fabricated by laser scribing or other means.

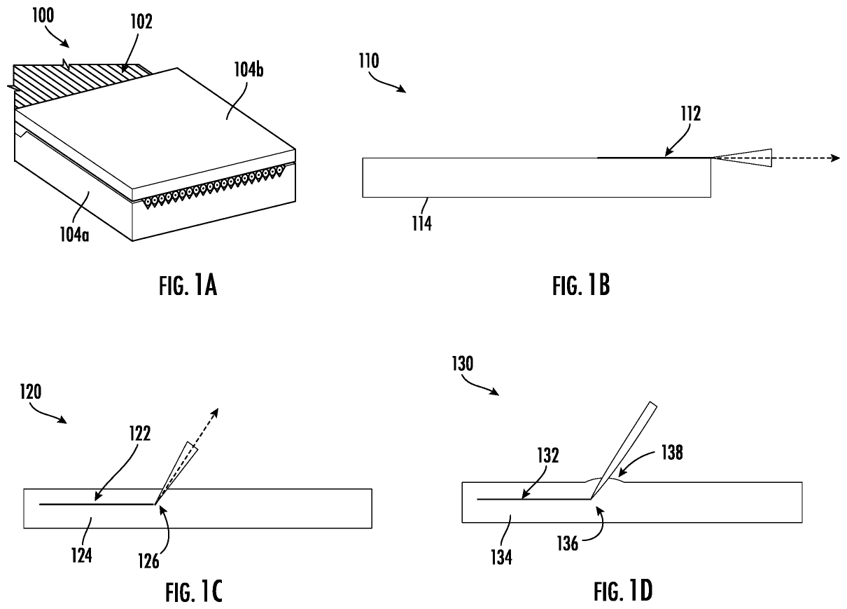

FIG. 1A is a perspective view of an array of waveguides 100 (i.e., a WGA), in accordance with an embodiment of the invention. As shown in FIG. 1A, the WGA 100 may include an array of optical fibers 102 fixed to substrates 104a and 104b (e.g., an FAU). The array of optical fibers 102 may guide information-carrying light from one location to another. In this regard, when the WGA 100 is not connected to or improperly aligned with another WGA, a portion of the light emitted from the ends of the optical fibers 102 will not couple into a corresponding end of another WGA due to mode mismatch, thereby causing signal loss.

FIGS. 1B-1D are schematic cross-sectional views of other WGAs 110, 120, and 130, in accordance with embodiments of the invention. As shown in FIG. 1B, the WGA 110 may include an array of waveguides 112 fabricated on a substrate and/or a PIC 114, where the waveguides 112 are edge-coupled. In this regard, the waveguides 112 terminate at the edge of the PIC 114 and emit light in a direction parallel to the PIC 114 (i.e., in-plane).

As shown in FIG. 1C, the WGA 120 may include an array of waveguides 122 fabricated on a substrate and/or a PIC 124, where the waveguides 122 are grating-coupled. In this regard, the WGA 120 may include surface-emitting grating couplers 126 at the ends of the waveguides 122 such that light is emitted out of plane from the PIC 124 at an angle.

As shown in FIG. 1D, the WGA 130 may include an array of waveguides 132 fabricated on a substrate and/or a PIC 134, where the waveguides 132 are grating-coupled and collimated. In this regard, the WGA 130 may include surface-emitting grating couplers 136 and optical components 138 (e.g., an array of microlenses) configured to collimate light emitted from the ends of the waveguides 132 at an angle from the PIC 134.

In this regard, a WGA may refer to an array of optical fibers fixed to a substrate (e.g., similar to the WGA 100 of FIG. 1A), an array of waveguides fabricated on a substrate and/or a PIC that are edge-coupled (e.g., similar to the WGA 110 of FIG. 1B), an array of waveguides fabricated on a substrate and/or a PIC with surface-emitting grating couplers (e.g., similar to the WGA 120 of FIG. 1C), an array of waveguides including grating couplers having optical components configured to collimate grating coupled light (e.g., similar to the WGA 130 of FIG. 1D), and/or the like. As will be appreciated by those of ordinary skill in the art in view of this disclosure, a WGA may also refer to other types of arrays of waveguides. For example, a WGA may be a linear, typically equally-spaced arrangement of waveguides which may include optic fibers, laser-scribed waveguides, and/or the like.

As will be appreciated by one of ordinary skill in the art in view of the present disclosure, the WGAs 100, 110, 120, and 130 may include additional components, alternative components, and/or the like. For example, the WGAs 100, 110, 120, and 130 may include one or more components for mechanically securing the arrays of waveguides, mechanically connecting the WGAs to other components, electrically connecting the WGAs to other components, and/or the like.

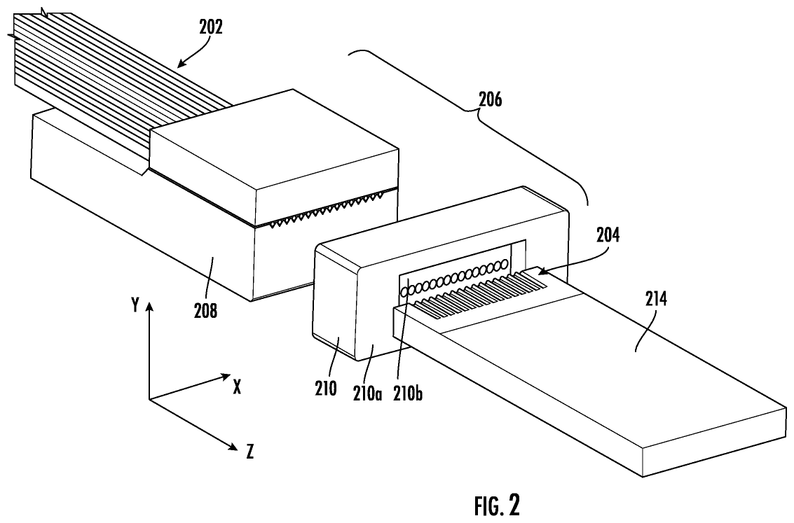

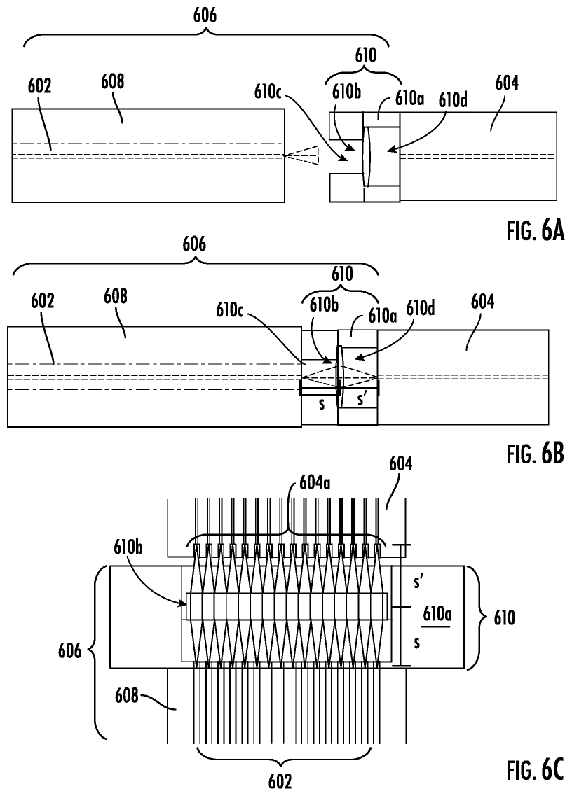

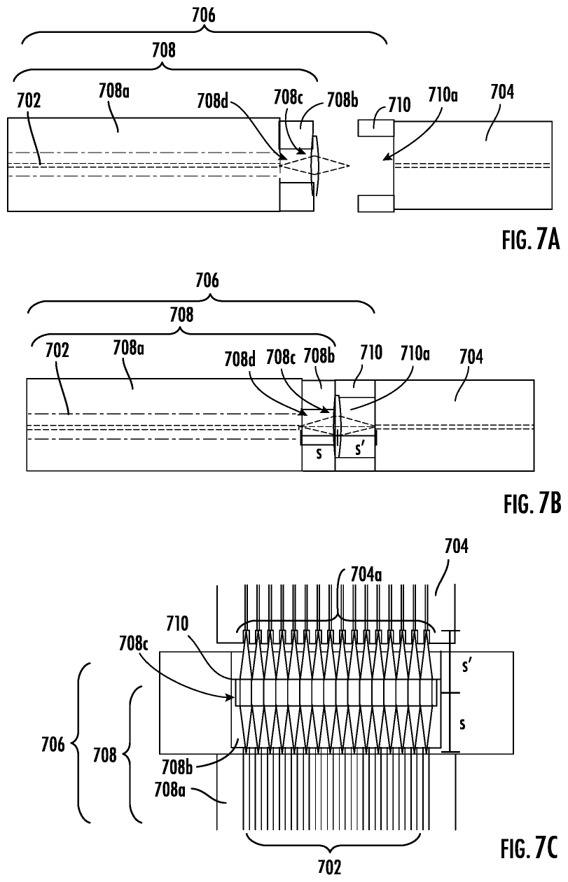

FIG. 2 is a perspective view of two WGAs 202 and 204 and an optical array connector 206, in accordance with an embodiment of the invention. As shown in FIG. 2, the optical array connector 206 may include a first component 208 mechanically connected to the first WGA 202 and a second component 210 mechanically connected to the second WGA 204. In the embodiment shown in FIG. 2, the first WGA 202 includes an array of optical fibers, and the second WGA 204 is fabricated on a PIC 214. As also shown in FIG. 2, the second component 210 may include a housing 210a and an MLA 210b. In this regard, the second component 210 may be similar to one or more of the components further described herein with respect to FIGS. 6A-6C, 7A-7C, and/or 8A-8C.

As previously described, optical connectors between WGAs must precisely optically align each pair of WGAs to ensure high-efficiency transmission of light from one WGA to the other WGA. In this regard, a variety of types of misalignments may occur when connecting two WGAs. For example, misalignments may occur due to low precision in alignment of optical components attached to one or both of the WGAs or alignment and assembly of the WGAs relative to each other. As another example, misalignments may occur due to degradation of a fixture that holds the two WGAs in designated positions, such as the degradation of an adhesive or a mechanical feature.

Additionally, misalignments between the two sides of an optical connector may cause misalignments of WGAs relative to the light path. For example, a lateral or transverse misalignment may occur when there is a linear relative shift along the x or y axis shown in FIG. 2 of a connector component. As another example, an angular tilt misalignment may occur when there is a relative rotation around the x or y axis shown in FIG. 2. As yet another example, a rotational misalignment may occur when there is a relative angular misalignment around the z axis shown in FIG. 2. Finally, an axial misalignment may occur when there is a relative shift along the z axis shown in FIG. 2. Optical connectors in accordance with some embodiments of the present invention may use an expanded-beam technique to optically align WGAs and increase resilience to different types of misalignments.

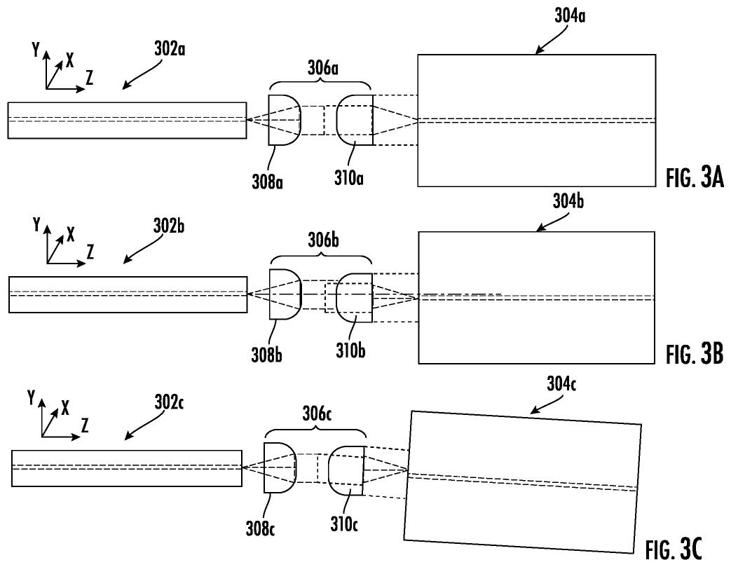

FIGS. 3A-3C are schematic top views of optical fibers coupled to single waveguide PICs by optical array connectors using an expanded-beam technique (e.g., to optically align the waveguides). As shown in FIG. 3A, an optical array connector 306a may include a first component 308a and a second component 310a to optically align a first WGA 302a (e.g., an array of optical fibers) with a second WGA 304a (e.g., a PIC). The first component 308a receives a light beam from each waveguide of the first WGA 302a and expands and collimates the light beams. The second component 310a receives the collimated light beams from the first component 308a and focuses each light beam on a respective waveguide of the second WGA 304a. As shown in FIG. 3A, when the optical array connector 306a optically aligns the two WGAs 302a and 304a, all of the light from the first WGA 302a is coupled into the second WGA 304a, and no energy is lost in the connection.

As shown in FIG. 3B, another optical array connector 306b may include a first component 308b and a second component 310b to optically align a first WGA 302b (e.g., an array of optical fibers) with a second WGA 304b (e.g., a PIC). Similar to FIG. 3A, the first component 308a may expand and collimate light beams from the first WGA 302b, and the second component 310b may receive and focus the light beams on the waveguides of the second WGA 304b. However, as shown in FIG. 3B, the optical array connector 306b has introduced a lateral misalignment between the two WGAs 302b and 304b. For example, the lateral misalignment may be a linear relative shift of the first WGA 302b together with attached first component 308b along the x or y axis shown in FIG. 3B, where the x axis extends into the page, relative to the second component 310b together with the second WGA 304b. When such a misalignment occurs using the expanded-beam technique, a majority of the light from the first WGA 302b is coupled into the second WGA 304b, and only a small portion of energy is lost in the connection. Thus, optical array connectors using such an expanded-beam technique may be more tolerant to lateral misalignments.

As shown in FIG. 3C, another optical array connector 306c may include a first component 308c and a second component 310c to optically align a first WGA 302c (e.g., an array of optical fibers) with a second WGA 304c (e.g., a PIC). Similar to FIGS. 3A and 3B, the first component 308c may expand and collimate light beams from the first WGA 302c, and the second component 310c may receive and focus the light beams on the waveguides of the second WGA 304c. However, as shown in FIG. 3C, the optical array connector 306c has introduced an angular misalignment between the two WGAs 302c and 304c. For example, the angular misalignment may be a rotation of 310c together with 304c around the x or y axis shown in FIG. 3C, where the x axis extends into the page relative to 302c together with 308c. When such a misalignment occurs using the expanded-beam technique, only a small portion of the light from the first WGA 302c is coupled into the second WGA 304c, and a majority of energy is lost in the connection. Thus, optical array connectors using such an expanded-beam technique may be more sensitive to angular misalignments. In this regard, expanded-beam-type embodiments of optical array connectors in accordance with the present invention may include a first component and a second component configured (e.g., sized, shaped, and/or otherwise structurally designed) to minimize and/or prevent angular misalignment of WGAs.

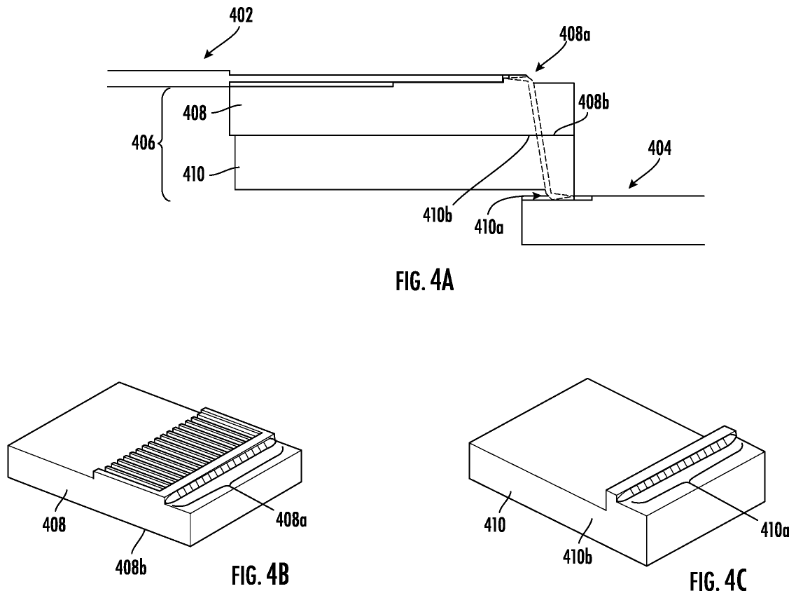

FIG. 4A is a cross-sectional view of two WGAs 402 and 404 connected by an optical array connector 406, in accordance with an embodiment of the invention. FIGS. 4B and 4C are perspective views of components 408 and 410 of the optical array connector 406 of FIG. 4A. In some embodiments, a first WGA 402 may include an array of optical fibers (e.g., an FAU), and a second WGA 404 may include a PIC.

As shown in FIG. 4A, the optical array connector 406 may include a first component 408 configured to mechanically connect to the first WGA 402. The first component 408 may include an array of curved surfaces 408a, where each curved surface corresponds to a respective waveguide of the first WGA 402. In some embodiments, and as shown in FIG. 4B, the array of curved surfaces 408a may include a plurality of lenses on an internal surface of the first component 408. Each lens may be configured to collimate a respective light beam within the first component 408. In some embodiments, the first component 408 may be manufactured from silicon, optical glass (e.g., fused silica), and/or the like. Additionally, or alternatively, the optical fibers of the first WGA 402 may be adhered to the first component 408 (e.g., into v-grooves fabricated on the first component 408).

As also shown in FIG. 4A, the optical array connector 406 may include a second component 410 configured to mechanically connect to the second WGA 404. The second component 410 may include an array of curved surfaces 410a, where each curved surface corresponds to a respective waveguide of the second WGA 404. In some embodiments, and as shown in FIG. 4C, the array of curved surfaces 410a may include a plurality of lenses on an internal surface of the second component 410. Each lens may be configured to focus a respective collimated light beam within the second component 410. In some embodiments, the second component 410 may be manufactured from silicon, optical glass (e.g., fused silica), and/or the like. Additionally, or alternatively, the second component 410 may be aligned with and permanently attached to the second WGA 404 (e.g., via an adhesive).

In some embodiments, and as shown in FIG. 4A, the first component 408 and the second component 410 may be configured to removably connect to each other, mechanically connect the first WGA 402 to the second WGA 404, and optically align each waveguide of the first WGA 402 with a corresponding waveguide of the second WGA 404. In particular, the first component 408 may be configured to expand and collimate each light beam from the first WGA 402 using a corresponding curved surface of the array of curved surfaces 408a and direct each collimated light beam to the second component 410. Additionally, the second component 410 may be configured to focus each collimated light beam onto a respective aperture (e.g., a core of an optical fiber) of a corresponding waveguide of the second WGA 404 using a corresponding curved surface of the array of curved surfaces 410a. In some embodiments, and as shown in FIG. 4A, the first component 408 may be configured to direct each light beam from the first WGA 402 to the second component 410 via total internal reflection. Additionally, or alternatively, and as shown in FIG. 4A, the second component 410 may be configured to direct each light beam from the first component 408 to the second WGA 404 via total internal reflection.

In some embodiments, the first component 408 and the second component 410 may each be enclosed in a mechanical receptacle. For example, the mechanical receptacles may be configured to removably connect to each other. Additionally, or alternatively, the mechanical receptacles may be configured to removably connect to each other while maintaining accurate and/or repeatable relative positioning of the first component 408 and the second component 410.

In some embodiments, the first component 408 and the second component 410 may each include a corresponding external surface configured to allow each light beam to pass therethrough. For example, and as shown in FIGS. 4A-4C, the first component 408 may include an external flat surface 408b, and the second component 410 may include an external flat surface 410b such that, when the first component 408 and the second component 410 are connected, the external flat surfaces 408b and 410b contact each other and permit light beams to pass with minimal energy loss.

As shown in FIG. 4A, the optical array connector 406 uses an expanded-beam technique to optically couple the first WGA 402 and the second WGA 404 and, therefore, may be less sensitive to lateral misalignments. Additionally, the corresponding external surfaces 408b and 410b of the first component 408 and the second component 410, respectively, may be configured (e.g., sized, shaped, and/or otherwise structurally designed) to minimize and/or prevent angular misalignment of the first WGA 402 and the second WGA 404. For example, the corresponding external surfaces 408b and 410b and the manner in which the first component 408 and the second component 410 are configured to mechanically connect to the first WGA 402 and the second WGA 404, respectively, may prevent relative angular misalignment of the first WGA 402 and the second WGA 404.

As will be appreciated by one of ordinary skill in the art in view of the present disclosure, the optical array connector 406 may include additional components, alternative components, and/or the like. For example, the optical array connector 406 may include one or more components for mechanically securing the first WGA 402 to the first component 408, mechanically securing the second WGA 404 to the second component 410, mechanically securing the first component 408 to the second component 410, and/or the like. As another example, the first component 408 and/or the second component 410 may be configured to perform the functions described herein with respect to FIGS. 4A-4C in a different manner, such as using differently configured surfaces.

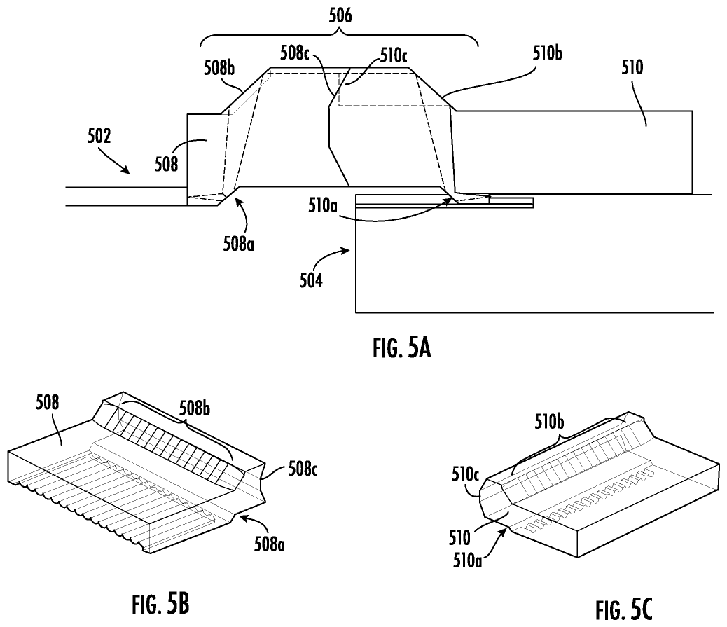

FIG. 5A is an elevation view of two WGAs 502 and 504 connected by an optical array connector 506, in accordance with an embodiment of the invention. FIGS. 5B and 5C are perspective views of components 508 and 510 of the optical array connector 506 of FIG. 5A. In some embodiments, a first WGA 502 may include an array of optical fibers, and a second WGA 504 may include a PIC.

As shown in FIG. 5A, the optical array connector 506 may include a first component 508 configured to mechanically connect to the first WGA 502. The first component 508 may include an internal surface 508a and an array of curved surfaces 508b, where each curved surface corresponds to a respective waveguide of the first WGA 502. In some embodiments, and as shown in FIG. 5B, the array of curved surfaces 508b may include a plurality of lenses on an internal surface of the first component 508. Each lens may be configured to collimate a respective light beam within the first component 508.

As also shown in FIG. 5A, the optical array connector 506 may include a second component 510 configured to mechanically connect to the second WGA 504. The second component 510 may include an internal surface 510a and an array of curved surfaces 510b, where each curved surface corresponds to a respective waveguide of the second WGA 504. In some embodiments, and as shown in FIG. 5C, the array of curved surfaces 510b may include a plurality of lenses on an internal surface of the second component 510. Each lens may be configured to focus a respective collimated light beam within the second component 510.

In some embodiments, and as shown in FIG. 5A, the first component 508 and the second component 510 may be configured to removably connect to each other, mechanically connect the first WGA 502 to the second WGA 504, and optically align each waveguide of the first WGA 502 with a corresponding waveguide of the second WGA 504. In particular, the first component 508 may be configured to direct each light beam from the first WGA 502 to the array of curved surfaces 508b using the internal surface 508a. The first component 508 may be further configured to expand and collimate each light beam using a corresponding curved surface of the array of curved surfaces 508b and direct each collimated light beam to the second component 510. Additionally, the second component 510 may be configured to focus each collimated light beam onto a respective aperture (e.g., a core of an optical fiber) of a corresponding waveguide of the second WGA 504 using a corresponding curved surface of the array of curved surfaces 510b. The second component 510 may be further configured to direct each focused light beam onto a respective aperture (e.g., a core of an optical fiber) of a corresponding waveguide of the second WGA 504 using the internal surface 510a. In some embodiments, and as shown in FIG. 5A, the first component 508 may be configured to direct each light beam from the first WGA 502 to the second component 510 via total internal reflection. Additionally, or alternatively, and as shown in FIG. 5A, the second component 510 may be configured to direct each light beam from the first component 508 to the second WGA 504 via total internal reflection.

In some embodiments, the first component 508 and the second component 510 may each include a corresponding external surface (e.g., a complimentarily shaped external surface) configured to allow each light beam to pass therethrough. For example, and as shown in FIGS. 5A-5C, the first component 508 includes an external surface 508c, and the second component 510 includes an external surface 510c such that when the first component 508 and the second component 510 are connected the external surfaces 508c and 510c contact each other and permit light beams to pass with minimal energy loss.

As shown in FIG. 5A, the optical array connector 506 uses an expanded-beam technique to optically couple the first WGA 502 and the second WGA 504 and, therefore, may be less sensitive to lateral misalignments. Additionally, the corresponding external surfaces 508c and 510c of the first component 508 and the second component 510, respectively, may be configured (e.g., sized, shaped, and/or otherwise structurally designed) to minimize and/or prevent angular misalignment of the first WGA 502 and the second WGA 504. For example, the corresponding external surfaces 508c and 510c and the manner in which the first component 508 and the second component 510 are configured to mechanically connect to the first WGA 502 and the second WGA 504, respectively, may prevent relative angular misalignment of the first WGA 502 and the second WGA 504.

As will be appreciated by one of ordinary skill in the art in view of the present disclosure, the optical array connector 506 may include additional components, alternative components, and/or the like. For example, the optical array connector 506 may include one or more components for mechanically securing the first WGA 502 to the first component 508, mechanically securing the second WGA 504 to the second component 510, mechanically securing the first component 508 to the second component 510, and/or the like. As another example, the first component 508 and/or the second component 510 may be configured to perform the functions described herein with respect to FIGS. 5A-5C in a different manner, such as using differently configured surfaces.

FIG. 6A is a schematic elevation view of two WGAs 602 and 604 and an optical array connector 606 before connection, in accordance with an embodiment of the invention. FIG. 6B is a schematic elevation view of the two WGAs 602 and 604 and the optical array connector 606 of FIG. 6A after connection. FIG. 6C is a schematic overhead view of the two WGAs 602 and 604 and the optical array connector 606 of FIG. 6A after connection. The optical array connector 606 may be referred to herein as a relay-type connector.

As shown in FIGS. 6A-6C, the optical array connector 606 may include a first component 608 configured to mechanically connect to a first WGA 602. In this regard, the first component 608 may include a fiber array unit (FAU) affixed to an array of optical fibers. In some embodiments, the first component 608 may include an MT-type connector.

As also shown in FIG. 6A-6C, the optical array connector 606 may include a second component 610 configured to mechanically connect to a second WGA 604. The second component 610 may include a housing 610a and a microlens array (MLA) 610b positioned within the housing 610a. The housing 610a may define a first side and a second side opposite the first side.

As shown in FIGS. 6B and 6C, each microlens of the MLA 610b may have a first focal point a first distance s from the first side of the MLA 610b and a second focal point a second distance s′ from the second side of the MLA 610b. As also shown in FIGS. 6B and 6C, the housing 610a may be configured to, when the first component 608 and the second component 610 are connected to each other, (i) position proximal apertures of the waveguides of the first WGA 602 the first distance s from the first side of the MLA 610b and (ii) position proximal apertures of the waveguides of the second WGA 604 the second distance s′ from the second side of the MLA 610b. In this regard, and as shown in FIGS. 6A and 6B, the second component 610 may include a first gap 610c between the MLA 610b and the first WGA 602. As also shown in FIGS. 6A and 6B, the second component 610 may include a second gap 610d between the MLA 610b and the second WGA 604.

As shown in FIG. 6A-6C, the second WGA 604 may include at least a portion of a PIC, and the second component 610 may be fixedly attached to the PIC. Additionally, or alternatively, the second component 610 may be formed as an integral part of at least a portion of a PIC. As shown in FIG. 6C, the second WGA 604 may include a plurality of v-grooves 604a providing access to the apertures of the waveguides of the second WGA 604. In some embodiments, the second WGA 604 may not include such v-grooves 604a and may be configured to provide access to the apertures of the waveguides in another manner.

In some embodiments, the second component 610 including the housing 610a and the microlens array (MLA) 610b may be configured to mechanically connect to the first WGA 602 including the array of optical fibers, rather than the second WGA 604 including the waveguides of the PIC. In this regard, the optical array connector 606 of FIGS. 6A-6C may be an alternative to MT-type connectors and/or MPO-type connectors. In contrast to MT-type connectors and MPO-type connectors, however, the optical array connector 606 of FIGS. 6A-6C may not require a high connection force to obtain tight contact of corresponding waveguides.

As will be appreciated by one of ordinary skill in the art in view of the present disclosure, the optical array connector 606 may include additional components, alternative components, and/or the like. For example, the optical array connector 606 may include one or more components for mechanically securing the first WGA 602 to the first component 608, mechanically securing the second WGA 604 to the second component 610, mechanically securing the first component 608 to the second component 610, and/or the like. As another example, the first component 608 and/or the second component 610 may be configured to perform the functions described herein with respect to FIGS. 6A-6C in a different manner, such as using a differently configured housing.

FIG. 7A is a schematic elevation view of two WGAs 702 and 704 and an optical array connector 706 before connection, in accordance with an embodiment of the invention. FIG. 7B is a schematic elevation view of the two WGAs 702 and 704 and the optical array connector 706 of FIG. 7A after connection. FIG. 7C is a schematic overhead view of the two WGAs 702 and 704 and the optical array connector 706 of FIG. 7A after connection. The optical array connector 706 may be referred to herein as a relay-type connector.

As shown in FIGS. 7A-7C, the optical array connector 706 may include a first component 708 configured to mechanically connect to a first WGA 702. In this regard, the first component 708 may include a fiber array unit (FAU) 708a affixed to an array of optical fibers. In some embodiments, the first component 708 may include an MT-type connector. As shown in FIGS. 7A-7C, the first component 708 may include a housing 708b and a microlens array (MLA) 708c positioned within the housing 708b. The housing 708b may define a first side and a second side opposite the first side.

As also shown in FIGS. 7A-7C the optical array connector 706 may include a second component 710 configured to mechanically connect to a second WGA 704. As shown in FIG. 7A-7C, the second WGA 704 may include at least a portion of a PIC, and the second component 710 may be fixedly attached to the PIC. Additionally, or alternatively, the second component 710 may be formed as an integral part of at least a portion of a PIC. As shown in FIG. 7C, the second WGA 704 may include a plurality of v-grooves 704a providing access to the apertures of the waveguides of the second WGA 704. In some embodiments, the second WGA 704 may not include such v-grooves 704a and may be configured to provide access to the apertures of the waveguides in another manner.

As shown in FIGS. 7B and 7C, each microlens of the MLA 708c may have a first focal point a first distance s from the first side of the MLA 708c and a second focal point a second distance s′ from the second side of the MLA 708c. As also shown in FIGS. 7B and 7C, the housing 708b and/or the second component 710 may be configured to, when the first component 708 and the second component 710 are connected to each other, (i) position proximal apertures of the waveguides of the first WGA 702 the first distance s from the first side of the MLA 708c and (ii) position proximal apertures of the waveguides of the second WGA 704 the second distance s′ from the second side of the MLA 708c. In this regard, and as shown in FIGS. 7A and 7B, the first component 708 may include a gap 708d between the MLA 708c and the first WGA 702. As also shown in FIGS. 7A and 7B, the second component 710 may include a gap 710a between the MLA 708c and the second WGA 704.

In some embodiments, the first component 708 including the housing 708b and the MLA 708c may be configured to mechanically connect to the second WGA 704 of the PIC, rather than the first WGA 702 including the array of optical fibers. In this regard, the optical array connector 706 of FIGS. 7A-7C may be an alternative to MT-type connectors and/or MPO-type connectors. In contrast to MT-type connectors and MPO-type connectors, however, the optical array connector 706 of FIGS. 6A-6C may not require a high connection force to obtain tight contact of corresponding waveguides.

As will be appreciated by one of ordinary skill in the art in view of the present disclosure, the optical array connector 706 may include additional components, alternative components, and/or the like. For example, the optical array connector 706 may include one or more components for mechanically securing the first WGA 702 to the first component 708, mechanically securing the second WGA 704 to the second component 710, mechanically securing the first component 708 to the second component 710, and/or the like. As another example, the first component 708 and/or the second component 710 may be configured to perform the functions described herein with respect to FIGS. 7A-7C in a different manner, such as using a differently configured housing.

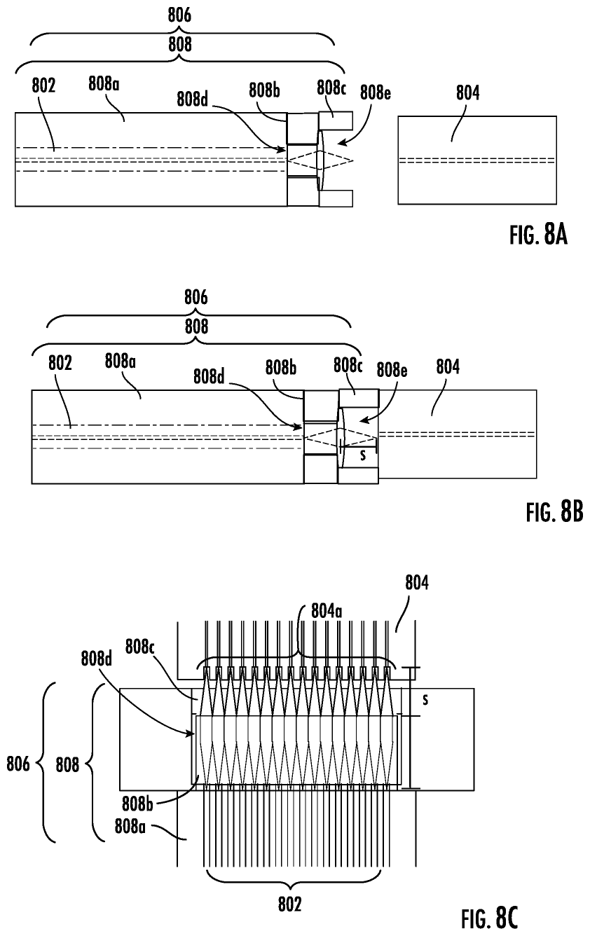

FIG. 8A is a schematic elevation view of two WGAs 802 and 804 and an optical array connector 806 before connection, in accordance with an embodiment of the invention. FIG. 8B is a schematic elevation view of the two WGAs 802 and 804 and the optical array connector 806 of FIG. 8A after connection. FIG. 8C is a schematic overhead view of the two WGAs 802 and 804 and the optical array connector 806 of FIG. 8A after connection. The optical array connector 806 may be referred to herein as a relay-type connector.

As shown in FIGS. 8A-8C, the optical array connector 806 may include a component 808 configured to mechanically connect to a first WGA 802. In this regard, the component 808 may include a fiber array unit (FAU) 808a affixed to an array of optical fibers. In some embodiments, the component 808 may include an MT-type connector.

As also shown in FIGS. 8A-8C, the component 808 may include a first housing 808b connected to the FAU 808a, a second housing 808c connected to the first housing 808b, and a microlens array (MLA) 808d positioned within the first housing 808b. The first housing 808b may define a first side and a second side opposite the first side.

As shown in FIGS. 8B and 8C, the second housing 808c may be configured to mechanically connect to a second WGA 804. As shown in FIG. 8A-8C, the second WGA 804 may include at least a portion of a PIC. As shown in FIG. 8C, the second WGA 804 may include a plurality of v-grooves 804a providing access to the apertures of the waveguides of the second WGA 804. In some embodiments, the second WGA 804 may not include such v-grooves 804a and may be configured to provide access to the apertures of the waveguides in another manner.

As shown in FIGS. 8A-8C, the MLA 808d may include a first surface positioned adjacent proximal apertures of the waveguides of the first WGA 802. As shown in FIGS. 8B and 8C, the MLA 808d may include a second surface having a plurality of microlenses formed thereon, where each microlens has a focal point a focal distance s from the second surface. As also shown in FIGS. 8B and 8C, the first housing 808b and/or the second housing 808c may be configured to, when the component 808 and the second WGA 804 are connected to each other, position proximal apertures of the waveguides of the second WGA 804 the focal distance s from the second surface of the MLA 808d. In this regard, and as shown in FIGS. 8A and 8B, the component 808 may include a gap 808e between the MLA 808d and the second WGA 804.

In some embodiments, the component 808 including the first housing 808b, the second housing 808c, and the MLA 808d may be configured to mechanically connect to the second WGA 804 of the PIC, rather than the first WGA 802 including the array of optical fibers. In this regard, the optical array connector 806 of FIGS. 8A-8C may be an alternative to MT-type connectors and/or MPO-type connectors. In contrast to MT-type connectors and MPO-type connectors, however, the optical array connector 806 of FIGS. 8A-8C may not require a high connection force to obtain tight contact of corresponding waveguides.

As will be appreciated by one of ordinary skill in the art in view of the present disclosure, the optical array connector 806 may include additional components, alternative components, and/or the like. For example, the optical array connector 806 may include one or more components for mechanically securing the first WGA 802 to the component 808, mechanically securing first housing 808b to the second housing 808c, mechanically securing the second housing 808c to the second WGA 804, and/or the like. As another example, the component 808 may be configured to perform the functions described herein with respect to FIGS. 8A-8C in a different manner, such as using differently configured housings, differently configured MLAs, and/or the like.

As described herein, optical connectors in accordance with some embodiments of the invention include expanded-beam type connectors (e.g., which use an expanded-beam technique) and relay-type connectors. As noted, for expanded-beam type connectors there may be a tradeoff for expanding the beam to larger diameters. In particular, expanding the beam to larger diameters may reduce sensitivity to lateral misalignments but increase sensitivity to angular misalignments. In this regard, Table 1 provides data demonstrating this tradeoff.

In particular, Table 1 provides connector types, maximum feasible lateral misalignments, maximum feasible angular misalignments, and radii of curvature for glass MLA for four different connectors in accordance with some embodiments of the invention. The maximum feasible lateral misalignments and maximum feasible angular misalignments may correspond to misalignments that result in levels of optical loss that are high but still satisfy an industry standard for optical connectors. As shown in Table 1, expanding the beam to larger diameters may reduce sensitivity to lateral misalignments but increase sensitivity to angular misalignments.

TABLE 1

| | Lateral | Angular | Radius of |
|---|---|---|---|
| | Misalignment | Misalignment | Curvature for Glass |
| Connector Type | (μm) | (mrad) | MLA (μm) |
| Beam expanded to | 2.87 | 7.74 | 61 |
| 42 μm | | | |
| Beam expanded to | 5.39 | 4.43 | 114 |
| 50 μm | | | |
| Beam expanded to | 13.73 | 1.571 | 330 |
| 132 μm | | | |
| Relay | 1.13 | 20.9 | N/A |

As will be appreciated by one of ordinary skill in the art in view of the present disclosure, the radius of curvature of an optical surface to achieve a particular beam size varies based on the material used to form the optical surface (e.g., an MLA). As noted in Table 1, the radii of curvature are provided for glass MLAs. In some embodiments, the MLAs may be, for example, silicon and may be higher due to a higher refractive index of silicon as compared to the refractive index of glass.

As will be appreciated by one of ordinary skill in the art in view of the present disclosure, a pitch of a WGA (e.g., a spacing between waveguides in the array) may establish an upper limit on beam diameter (e.g., for both expanded-beam type connectors and relay-type connectors). For example, a connector for a WGA with a pitch of 127 microns may not expand beam diameter as much as another connector for another WGA with a pitch of 250 microns.

As will be appreciated by one of ordinary skill in the art in view of the present disclosure, the precision of alignment of mechanical receptacles of an optical connector may be considered when determining a diameter of expanded beams for optically aligning waveguides. For example, if mechanical receptacles of an optical connector only provide a lateral alignment precision of 2 microns, then the optical connector must use an expanded-beam technique that is tolerant of lateral misalignments greater than 2 microns. In such an example, the relay-type connector of Table 1 would be unsuitable because lateral misalignments greater than 1.13 are not feasible for such a connector.

As another example, if mechanical receptacles of an optical connector only provide an angular alignment precision of 5 milliradians, then the optical connector must use an expanded-beam technique that is tolerant of angular misalignments greater than 5 milliradians. In such an example, the expanded-beam-type connector of Table 1 that expand the beams to 132 microns would be unsuitable because angular misalignments greater than 1.571 milliradians are not feasible for such a connector. Furthermore, in such an example, the expanded-beam-type connector of Table 1 that expand the beams to 50 microns would be unsuitable because angular misalignments greater than 4.43 milliradians are not feasible for such a connector. As will be appreciated by one of ordinary skill in the art in view of the present disclosure, optical connectors in accordance with embodiments of the present invention may be designed taking into account the foregoing design considerations and guidance.

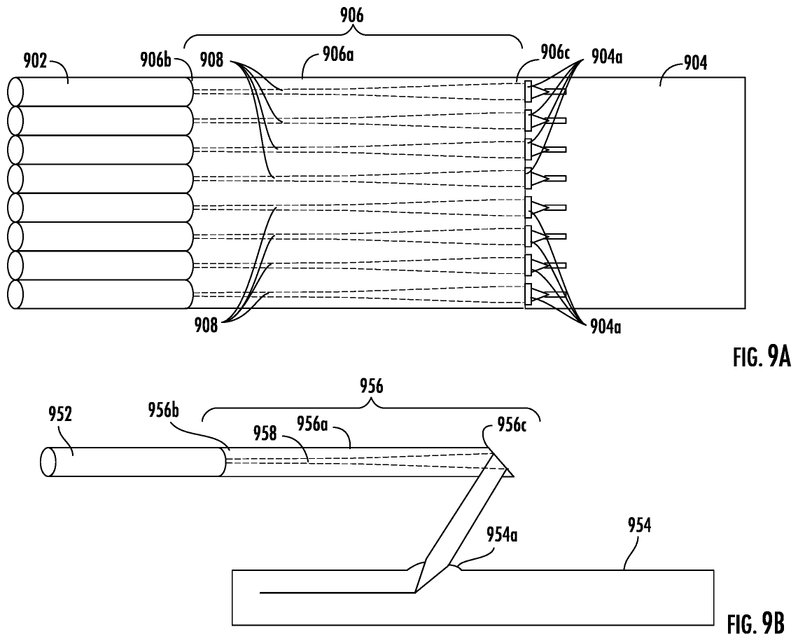

FIG. 9A is a schematic overhead view of two WGAs 902 and 904 and an optical array connector 906, in accordance with an embodiment of the invention. In some embodiments, a first WGA 902 may include an array of optical fibers, and a second WGA 904 may include a PIC. As shown in FIG. 9A, the second WGA 904 may include a plurality of optical components 904a (e.g., an array of lenses) configured to focus light from the optical array connector 906 onto proximal apertures of the second WGA 904. In some embodiments, rather than the second WGA 904 including such optical components 904a, the optical array connector 906 may include optical components configured to focus light onto proximal apertures of the second WGA 904. Additionally, or alternatively, the optical array connector 906 and the second WGA 904 may each include optical components configured to operate together to focus light from the optical array connector 906 onto proximal apertures of the second WGA 904.

As shown in FIG. 9A, the optical array connector 906 may include a substrate 906a including a first side 906b configured to mechanically connect to the first WGA 902 and a second side 906c configured to mechanically connect to the second WGA 904. As also shown in FIG. 9A, the optical array connector 906 may include a third WGA 908 disposed on the substrate 906a and between the first WGA 902 and the second WGA 904. The third WGA 908 may be configured to collimate each light beam from the first WGA 902 and couple each collimated light beam to a corresponding waveguide of the second WGA 904. In some embodiments, and as shown in FIG. 9A, the third WGA 908 may be configured to controllably and/or adiabatically expand each light beam from the first WGA 902. As also shown in FIG. 9A, the third WGA 908 may extend from the first side 906b of the substrate 906a to the second side 906c of the substrate 906a.

In some embodiments, the third WGA 908 may be fabricated on the substrate 906a via lithography and/or laser inscription. Additionally, or alternatively, the optical array connector 906 and/or the substrate 906a may include a planar lightwave circuit, performing additional functions such as dispersion correction.

As will be appreciated by one of ordinary skill in the art in view of the present disclosure, the optical array connector 906 may include additional components, alternative components, and/or the like. For example, the optical array connector 906 may include one or more components for mechanically securing the first WGA 902 to the substrate 906a, mechanically securing the substrate 906a to the second WGA 904, and/or the like. As another example, the optical array connector 906 may be configured to perform the functions described herein with respect to FIG. 9A in a different manner, such as using a differently configured substrate, differently configured optical components, differently configured WGAs, and/or the like.

FIG. 9B is a schematic elevation view of two WGAs 952 and 954 and an optical array connector 956, in accordance with an embodiment of the invention. In some embodiments, a first WGA 952 may include an array of optical fibers, and a second WGA 954 may include a PIC. As shown in FIG. 9B, the second WGA 954 may include a plurality of optical components 954a (e.g., grating couplers, collimated grating couplers, a MLA, and/or the like) configured to focus light from the optical array connector 956 onto proximal apertures of the second WGA 954. In some embodiments, rather than the second WGA 954 including such optical components 954a, the optical array connector 956 may include optical components configured to focus light onto proximal apertures of the second WGA 954. Additionally, or alternatively, the optical array connector 956 and the second WGA 954 may each include optical components configured to operate together to focus light from the optical array connector 956 onto proximal apertures of the second WGA 954.

As shown in FIG. 9B, the optical array connector 956 may include a substrate 956a including a first side 956b configured to mechanically connect to the first WGA 952. Although not shown in FIG. 9B, the optical array connector 956 may include one or more components configured to mechanically connect a second side 956c of the substrate 956a to the second WGA 954. As shown in FIG. 9B, the optical array connector 956 may include a third WGA 958 disposed on the substrate 956a. The third WGA 958 may be configured to collimate each light beam from the first WGA 952 and couple each collimated light beam to a corresponding waveguide of the second WGA 954. In some embodiments, and as shown in FIG. 9B, the third WGA 958 may be configured to controllably and/or adiabatically expand each light beam from the first WGA 952. As also shown in FIG. 9B, the third WGA 958 may extend from the first side 956b of the substrate 956a to the second side 956c of the substrate 956a.

In some embodiments, the third WGA 958 may be fabricated on the substrate 956a via lithography and/or laser inscription. Additionally, or alternatively, the optical array connector 956 and/or the substrate 956a may include a planar lightwave circuit, performing additional functions such as dispersion correction.

As shown in FIG. 9B, the second side 956c of the substrate 956a may be angle-polished. In this regard, the angle-polished second side 956c may be configured to reflect (e.g., via total internal reflection and/or due to a reflective coating on the angle-polished second side 956c) light from the third WGA 958 to the second WGA 954. In some embodiments, and as shown in FIG. 9B, the angle-polished second side 956c may be configured to reflect the light at an angle with respect to the substrate 956a.

As will be appreciated by one of ordinary skill in the art in view of the present disclosure, the optical array connector 956 may include additional components, alternative components, and/or the like. For example, the optical array connector 956 may include one or more components for mechanically securing the first WGA 952 to the substrate 956a, mechanically securing the substrate 956a to the second WGA 954, and/or the like. As another example, the optical array connector 956 may be configured to perform the functions described herein with respect to FIG. 9B in a different manner, such as using a differently configured substrate, differently configured optical components, differently configured WGAs, and/or the like.

As will be appreciated by one of ordinary skill in the art in view of this disclosure, the present invention may include and/or be embodied as an apparatus (including, for example, a system, a machine, a device, and/or the like), as a method (including, for example, a manufacturing method, a robot-implemented process, and/or the like), or as any combination of the foregoing.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other changes, combinations, omissions, modifications, and substitutions, in addition to those set forth in the above paragraphs, are possible. Those skilled in the art will appreciate that various adaptations, modifications, and combinations of the just described embodiments may be configured without departing from the scope and spirit of the invention. For example, devices, modules, components, and/or elements shown in the figures are not necessarily drawn to scale and may vary from that shown without departing from the scope and spirit of the invention. Therefore, it is to be understood that, within the scope of the appended claims, the invention may be practiced other than as specifically described herein.

What is claimed is:

1. An optical array connector, comprising:
a first component configured to mechanically connect to a first array of first waveguides, wherein the first component comprises a first array of first curved surfaces, each first curved surface corresponding to a respective first waveguide; and
a second component configured to mechanically connect to a second array of second waveguides, wherein the second component comprises a second array of second curved surfaces, each second curved surface corresponding to a respective second waveguide;
wherein the first component and the second component are configured to:
removably connect to each other;
mechanically connect the first array to the second array; and
optically align each first waveguide with a corresponding second waveguide;
wherein the first component is configured to expand and collimate each light beam from the first array of first waveguides using a corresponding first curved surface and direct each collimated light beam to the second component; and
wherein the second component is configured to focus each collimated light beam onto a respective aperture of a corresponding second waveguide of the second array of second waveguides using a corresponding second curved surface.

2. The optical array connector of claim 1, wherein the first array of first waveguides comprises at least one of:
an array of optical fibers fixed to a substrate;
an array of waveguides fabricated on a substrate or a photonic integrated circuit that are edge-coupled;
an array of waveguides fabricated on a substrate or a photonic integrated circuit with surface-emitting grating couplers; or
an array of waveguides comprising grating couplers having optical components configured to collimate grating coupled light.

3. The optical array connector of claim 1, wherein the second array of second waveguides comprises at least one of:
an array of optical fibers fixed to a substrate;
an array of waveguides fabricated on a substrate or a photonic integrated circuit that are edge-coupled;
an array of waveguides fabricated on a substrate or a photonic integrated circuit with surface-emitting grating couplers; or
an array of waveguides comprising grating couplers having optical components configured to collimate grating coupled light.

4. The optical array connector of claim 1, wherein the first component is configured to direct each collimated light beam to the second component via total internal reflection.

5. The optical array connector of claim 4, wherein:
the first array of first curved surfaces comprises a plurality of first lenses on a first internal surface of the first component, wherein each first lens is configured to collimate a respective light beam within the first component; and
the second array of second curved surfaces comprises a plurality of second lenses on a second internal surface of the second component, wherein each second lens is configured to focus a respective collimated light beam within the second component.

6. The optical array connector of claim 5, wherein;
the first component is configured to reflect each light beam from the first array of first waveguides and direct each collimated light beam to the second component using the first internal surface;
each of the first component and the second component comprises a corresponding external flat surface configured to allow each collimated light beam to pass therethrough; and
the second component is configured to direct each focused light beam into a respective aperture of a corresponding second waveguide using the second internal surface.

7. The optical array connector of claim 5, wherein:
the first component comprises a third internal surface, and the first component is configured to (i) direct each light beam from the first array of first waveguides to the first internal surface using the third internal surface and (ii) direct each collimated light beam to the second component using the first internal surface;
each of the first component and the second component comprises a complementarily shaped external surface configured to allow each collimated light beam to pass therethrough; and
the second component comprises a fourth internal surface, and the second component is configured to (i) direct each focused light beam to the fourth internal surface using the second internal surface and (ii) direct each focused light beam into a respective aperture of a corresponding second waveguide using the fourth internal surface.

8. An optical array connector, comprising:
a first component configured to mechanically connect to a first array of first waveguides; and
a second component configured to mechanically connect to a second array of second waveguides, wherein the second component comprises a housing and a microlens array positioned within the housing;
wherein the first component and the second component are configured to:
removably connect to each other;
mechanically connect the first array to the second array; and
optically align each first waveguide with a respective second waveguide.

9. The optical array connector of claim 8, wherein:
the housing defines a first side and a second side opposite the first side;
each microlens of the microlens array has a first focal point a first distance from the first side of the microlens array and a second focal point a second distance from the second side of the microlens array; and
the housing is configured to, when the first component and the second component are connected to each other, (i) position proximal apertures of the first waveguides the first distance from the first side of the microlens array and (ii) position proximal apertures of the second waveguides the second distance from the second side of the microlens array.

10. The optical array connector of claim 8, wherein the second array of second waveguides is a portion of a photonic integrated circuit, and wherein the second component is fixedly attached to the photonic integrated circuit.

11. The optical array connector of claim 8, wherein:
the first component is a photonic integrated circuit; and
the second component is a fiber array unit.

12. The optical array connector of claim 11, wherein:
the housing defines a first side and a second side opposite the second side;
each microlens of the microlens array has a first focal point a first distance from the first side of the microlens array and a second focal point a second distance from the second side of the microlens array; and
the housing is configured to, when the fiber array unit and the photonic integrated circuit are connected to each other, (i) position proximal apertures of the first waveguides the first distance from the first side of the microlens array and (ii) position proximal apertures of the second waveguides the second distance from the second side of the microlens array.

13. The optical array connector of claim 11, wherein:
the microlens array comprises a first surface positioned adjacent proximal apertures of the second waveguides;
the microlens array comprises a second surface having a plurality of microlenses formed thereon, wherein each microlens of the plurality of microlenses has a first focal point a first distance from the second surface; and
the housing is configured to, when the fiber array unit and the photonic integrated circuit are connected to each other, position proximal apertures of the first waveguides the first distance from the second surface of the microlens array.

14. An optical array connector, comprising:
a substrate comprising:
a first side configured to mechanically connect to a first array of first waveguides; and
a second side configured to mechanically connect to a second array of second waveguides; and
a third array of third waveguides disposed on the substrate and configured to collimate and couple each light beam from the first array of first waveguides to a corresponding second waveguide.

15. The optical array connector of claim 14, wherein each third waveguide expands a corresponding light beam from a corresponding first waveguide.

16. The optical array connector of claim 14, wherein the third array of third waveguides is fabricated on the substrate via lithography.

17. The optical array connector of claim 14, wherein the substrate comprises a planar lightwave circuit.

18. The optical array connector of claim 14, comprising an array of optical components, wherein each optical component is configured to focus a respective collimated light beam onto a corresponding proximal aperture of the corresponding second waveguide.

19. The optical array connector of claim 14, wherein the second side of the substrate is angle-polished and configured to direct light from the third array of third waveguides to the second waveguide.

20. The optical array connector of claim 19, wherein the second side is configured to direct the light at an angle with respect to the substrate.
